(19) United States
(12) Patent Application Publication
(10) Pub. No.: US 2008/0063593 A1
(43) Pub. Date: Mar. 13, 2008

(54) Low temperature process for regenerating spent sulfuric acid

(75) Inventors: Lawrence A. Smith, Houston, TX (US); Abraham P. Gelbein, Raleigh, NC (US)

Correspondence Address: OSHA LIANG LLP / CDTECH, 1221 MCKINNEY STREET, SUITE 2800, HOUSTON, TX, 77010, US

(73) Assignee: Catalytic Distillation Technologies

(21) Appl. No.: 11/517,773

(22) Filed: Sep. 8, 2006

(51) Int. Cl. C01B 17/90

(52) U.S. Cl. 423/531; 423/525

(57) ABSTRACT

A process for the regeneration of spent sulfuric acid comprises decomposing the spent sulfuric acid to SO₂, a reducing agent, such as hydrocarbon and water, preferably in a thin film on a solid surface in the presence of a hydrocarbon reducing agent. The SO₂ generated in the decomposition step is converted to SO₃ in the presence of water and concentrated sulfuric acid is condensed out.

### BACKGROUND OF THE INVENTION

1. Field of the Invention

The present invention relates to a process for the regeneration of spent sulfuric acid containing hydrocarbons and water, such as sulfuric acid catalyzed reactions.

2. Related Information

Concentrated sulfuric acid is a strong Bronsted acid used in a variety of chemical processes to promote acid catalyzed reactions. Some examples include the alkylation of isobutane with C₄ olefins to produce high octane gasoline alkylate, production of caprolactam from cyclohexanone oxime, production of methyl methacrylate from acetone cyanohydrin, and production of nitrobenzene from benzene and nitric acid. All such processes produce a spent acid stream of reduced acid concentration containing a variety of organic compounds. Recovery and recycle of the sulfuric acid content of these streams is necessary since simple disposal of the spent acid, e.g., in deep wells, is not an environmentally acceptable option.

Current technologies for handling such streams involve (a) introducing the spent acid into a furnace fired by an air/hydrocarbon fuel mixture wherein the spent acid is converted to sulfur dioxide, water, and carbon dioxide, (b) partially cooling the combustion gas in a waste heat boiler, (c) treating the gas to remove particulates, (d) converting the sulfur dioxide in the gas to sulfur trioxide (by reaction with oxygen in the gas stream) in a fixed bed reactor system containing a vanadia catalyst with or without pretreatment to remove the water contained in the gas stream, and (e) recovering the sulfur trioxide as concentrated sulfuric acid via absorption in dilute sulfuric acid or direct condensation if water is present in the gas stream. The vent gas, after treatment to remove acid mist, generally contains carbon dioxide, oxygen, nitrogen, and a small amount of residual sulfur dioxide.

In a typical refinery or chemical application low cost spent acid disposal is not an option because of environmental regulations. Generally, the amount of spent acid produced is not sufficient to justify installation of an onsite conventional acid regeneration facility. The alternative is to ship the spent acid to a large scale sulfuric acid plant serving multiple spent acid generators and to receive pure acid in exchange. Most generators of spent acid have found that regenerating their spent acid onsite using current technology is a poor choice when compared to shipping the acid to a large centrally located acid production and regeneration facility serving several customers and having fresh acid returned because of the economy of scale. This alternative is not particularly attractive when compared to the cost of fresh acid.

It is an advantage that the present invention provides a reduced cost method for regenerating spent acid that can be practiced economically at relatively low volumes. It is a further advantage of the present invention that it provides an economically acceptable method for the onsite regeneration of spent sulfuric acid. Another advantage is that the present process provides an environmentally acceptable method for the onsite regeneration of spent sulfuric acid.

### SUMMARY OF THE INVENTION

Briefly the invention comprises the regeneration of spent sulfuric acid by decomposition of the spent acid to SO₂ and water in the presence of a reducing agent at a temperature in the range of 300 to 600° F., preferably less than about 500° F. The reduction is preferably carried out in a thin film on a solid surface. The reducing agent may be hydrocarbon, such as that contained within the spent sulfuric acid. If necessary, additional reducing agent, such as gas oil may be added. Preferably a portion of the particulate carbon, which is precipitated out with hydrocarbon reducing agents may be recycled and used as the solid surface for the decomposition reaction.

The SO₂ generated in the reducing step is converted to SO₃ in the presence of water and concentrated sulfuric acid is condensed out and recovered. The heat generated in the conversion of SO₂ to SO₃ may be recovered and used to provide heat for the decomposition reaction.

### BRIEF DESCRIPTION OF THE DRAWINGS

FIG. 1 is a simplified flow diagram in schematic form of the front decomposition section of one embodiment of the invention.

FIG. 2 is a simplified flow diagram in schematic form of the back SO₂ conversion section of one embodiment of the invention.

### DETAILED DESCRIPTION OF A PREFERRED EMBODIMENT

More particularly the invention relates to a process wherein the sulfuric acid is regenerated by first decomposition to SO₂ and water in the presence of a hydrocarbon reducing agent and the SO₂ subsequently converted to SO₃ which is converted to concentrated sulfuric acid. The process of the present invention is the regeneration of spent sulfuric acid contaminated with water to produce pure concentrated acid comprising the steps of:

(a) dispersing the spent sulfuric acid onto a solid surface as a thin layer in a decomposition zone and

(b) heating the resultant mixture in the presence of a reducing agent to decompose the spent sulfuric acid to sulfur dioxide and water. Preferred embodiments include decomposition temperature in the range of 300 to 600° F., more preferably about or less than 500° F.; a reducing agent comprising hydrocarbon contaminant which is decomposed to carbon and precipitated out of the mixture as solid particulates; the solid surface comprising a portion of precipitated solid carbon particulates; converting the sulfur dioxide to sulfur trioxide in a converter by reacting the sulfur dioxide with oxygen in the presence of water; condensing sulfuric acid of about one hundred percent sulfuric acid; and heat being recovered from the conversion of sulfur dioxide to sulfur trioxide and used to provide heat to the decomposition zone.

It was discovered that strong sulfuric acid (90+%) can be reduced to sulfur dioxide and water by reaction with a suitable reducing agent at elevated temperatures. High boiling hydrocarbons such as those present in gas oils or already present in the spent acid are suitable reducing agents. It was further discovered that some of the carbon and hydrogen values in the hydrocarbon can report as a solid phase or as carbon dioxide and water depending on the reaction time and temperature. The stoichiometry is shown below for reactions in which the hydrocarbon is converted only to carbon (1) or to carbon dioxide (2) using eicosane (C₂₀H₄₂) as model compound:

21H₂SO₄+C₂₀H₄₂==21SO₂+42H₂O+20C ΔH_{500F}=−8292 btu/lb mol H₂SO₄ (1)

61H₂SO₄+C₂₀H₄₂==61SO2+82H₂O+20CO₂ ΔH_{500F}=+7291 (2)

Those skilled in the art recognize that spent acid furnace combustion technology suffers from the fact that ash components in the spent acid accumulate on the tube surfaces of the waste heat boiler. Frequent shutdowns of the system are required to clean out the tubes so as to maintain an acceptable heat transfer rate. This is expensive with regard to maintenance cost and to operating efficiency (on-stream time). Clearly it is desirable to have an acid decomposition system that does not have this maintenance problem. An intractable solid phase is not formed if the acid is first dispersed as a relatively thin layer on a solid surface and then heated to reaction temperature by conductive, convective or radiant heat transfer.

Any type of flat or curved surface can be used. For example the surface can be a flat plate as in a continuous belt tunnel dryer or the curved surface of a rotating vacuum drum dryer. The carbonaceous residue can be readily removed from such surfaces in powder form by scraping with a “doctor” blade at the discharge end of the dryer while the gas phase is removed from the dryer enclosure by a blower.

The reaction type (1) can be the predominating reaction at an appropriate temperature. In the case of spent acid from a gasoline alkylate plant the temperature is preferably in the range of about 500° F. or less. Any ash present in the feed acid ends up residing in the resulting solid phase avoiding the production of a high temperature ash phase and the related tube fouling problem described above.

Alternatively, the spent acid can be deposited unto the surface of small particulates which can be transported through a heated zone, for example as in a hollow paddle/screw type processor (heat transfer fluid circulated through the paddles/screw) or as in a fluidized bed (heat transfer fluid circulated through tubes immersed in the bed; bed fluidized by recycling gas phase). In this case heat is transferred from the equipment heat transfer surface to the inventory of particulates which in turn functions as the heat source for the decomposition reaction. The carbonaceous residue can be removed from the particles by shaking and screening devices after which the residue free particulates are recycled. The weight ratio of the spent acid feed to the recycled solids determines the initial acid loading on the solids. This ratio can be varied over a wide range, from about 0.01 to 0.5, depending on the flow characteristics of the acid/solid mixture.

In a preferred mode of the invention the particulates can be the recycled carbonaceous residue powder itself. The net product is then simply withdrawn as a slip stream from the mechanically mixed or fluidized bed of solids at the rate needed to maintain a constant solids inventory in the system.

In another preferred mode the decomposition reactor is maintained under slight vacuum.

In another preferred mode, if the hydrocarbon impurity in the spent acid has insufficient reducing capacity to convert all the sulfuric acid to SO₂, external hydrocarbon is added to the spent acid feed in an amount sufficient to ensure the complete conversion of the acid to SO₂.

In another embodiment a novel energy efficient process is used for producing concentrated sulfuric acid from the decomposition step vapor product comprising:

(a) maintaining the H₂O/SO₂ mole ratio in the feed to the SO₂/SO₃ converter at one or slightly greater than one and using oxygen or oxygen enriched air as the oxidant. This contrasts with the prior conventional dry (Monsanto type) or wet (Haldor Topsoe type) technologies: the former resorting to the removal of all water from the feed generated in the fuel/air/acid combustion zone or the latter which uses the wet feed and subsequent water removal in downstream processing.

(b) using as the converter a single shell and multi-tube configuration fixed bed reactor system. Catalyst, such as the vanadia used in the prior art, is in the tubes; molten salt (HiTec®) coolant is in the shell. The temperature profile in the tubes is controlled by adjusting coolant temperature and flow rate. Prior conventional technology uses a series of adiabatic fixed bed reactors with inter-stage blowers and coolers.

(c) linking converter and decomposer heat exchange systems so that the heat generated in the former at higher temperature (˜700° F.) provides most of the endothermic heat requirement for the latter operating at lower temperature (˜500° F.). The heat exchange can be done directly (HiTec® is heated in the converter exchanger system and cooled in the decomposer exchanger system) or indirectly (e.g., via a Dowtherm® system which links the converter and decomposer heat exchanger systems). Prior conventional technology requires the addition of external fuel for decomposition.

(d) producing essentially 100% H₂SO₄ from the converter by direct condensation (at ˜500° F.) in a boiler. High pressure (600 psi) steam is generated. The large amount of heat generated results from the reaction between SO₃ and H₂O to form liquid H₂SO₄. In contrast the prior conventional dry system absorbs the SO₃ in dilute H₂SO₄ to generate the concentrated H₂SO₄ while the wet system uses a countercurrent condenser/stripper system to generate the product acid. In both cases high temperature heat is not recovered.

(e) scrubbing the low volume of tail gas with cold spent acid feed to essentially eliminate SO₂ emission in the process tail gas. The FIGURES illustrate regenerating spent sulfuric acid from a gasoline alkylate plant generating 12,500 lb/h of spent acid. Table 1 provides the stream flows. Composition of the spent acid (stream 4) is 92.0 wt % H₂SO₄, 5.0 wt % C₂₀H₄₂, and 3.0 wt % H₂O.

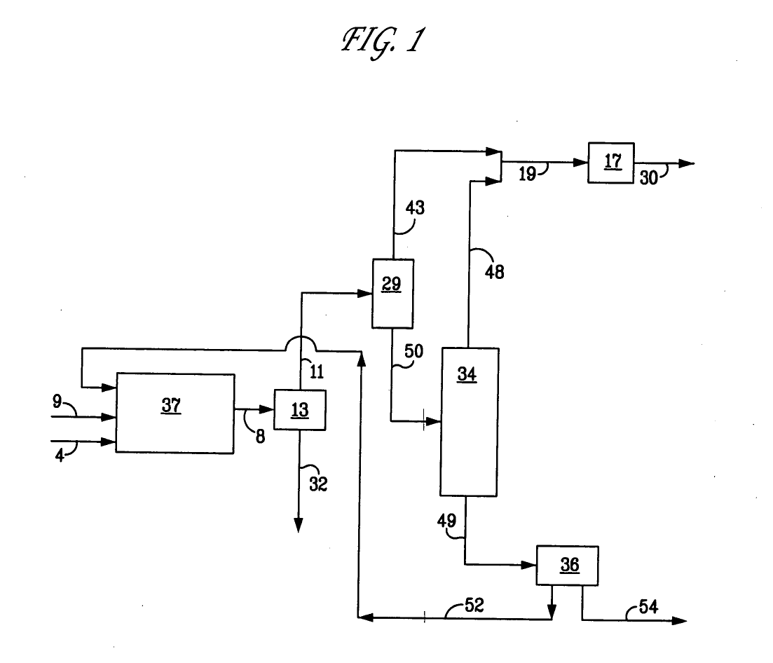

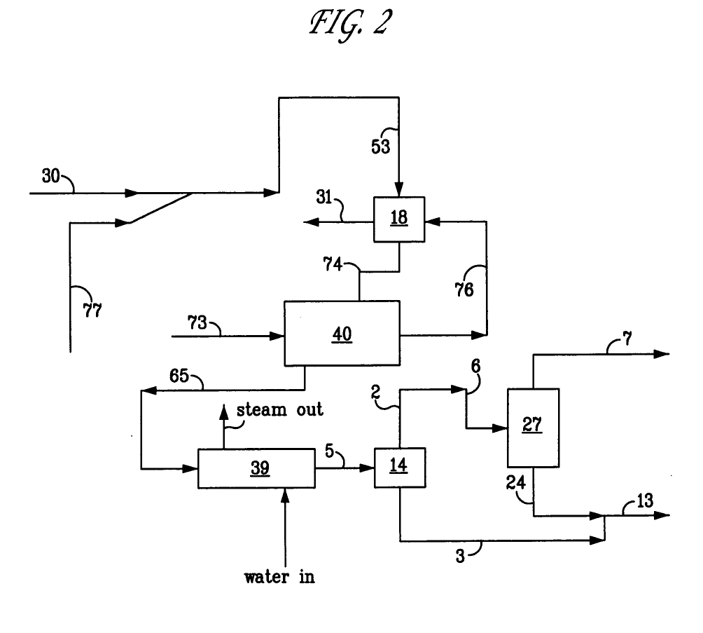

Referring now to FIGS. 1 and 2 the process is described in more detail.

The decomposition reaction is carried out in paddle/screw decomposer system (37/13). Component 13 comprises a conveying system for recycling the carbonaceous particulates to the feed end of the decomposer. A hot heat transfer fluid at ˜700° F. (not shown) is circulated through the paddle/screw and jacket (not shown) of the vessel providing the heat of reaction (˜5 MM btu/h). Spent acid feed (stream 4) and a requisite amount of gas oil (stream 9 modeled as C₂₀H₄₂) to ensure complete conversion of the acid is sprayed at ambient temperature onto the agitated solids. Net carbonaceous product is removed via stream 32.

Stream 11 is the vapor effluent from the decomposer comprising SO₂, water, a small amount of gas oil, and possibly a small amount of particulates. Stream 11 is cooled and partially condensed in an appropriate system (simply shown as condenser and drum 29) to knock out the contained hydrocarbon and to remove particulates. Overheads 43 comprise mainly SO₂ and some water vapor, Condensate stream 50 containing mainly water, some entrained SO₂ and hydrocarbon is fed to water stripper 34 which separates stream 50 into bottoms fraction stream 49 (containing the hydrocarbon vaporized in the decomposer, the water from the hydrocarbon oxidation reaction, and the water in the spent acid feed) and overhead vapor stream 48 contain water and SO₂. The reboiler duty for column 34 is −4MM btu/h which can be provided by low pressure stream (reboiler temperature is 206° F.). Streams 43 and 48 are combined to form stream 19 which contains essentially only SO₂ and H₂O in 1:1 mole ratio.

Stream 19 is suction fed to converter feed compressor 17 and exits as stream 30 which is at a pressure sufficient to overcome the pressure drop through the converter and downstream acid recovery system described in FIG. 2

Stream 49 goes to oil/water decanter 36 where excess water is removed as stream 54 and the oil phase 52 recycled to paddle/screw decomposer system (37/13).

Stream 30 is mixed with oxygen in stream 77 to form stream 53 which becomes stream 74 feed to the converter 40 after preheat to reaction temperature by exchange in exchanger 18 with the molten salt heat transfer fluid 31 circulating through the shell (not shown) of the paddle/screw decomposer system (37/13). The oxygen level in the feed 74 is in approximate 10 mole % excess. The stream 73 is the return from the paddle/screw decomposer system (37/13) for indirect heat exchange reheating in the converter 40 by the reaction. The reheated stream 73 passes as stream 76 to the heat exchanger 18. SO₂ conversion across the converter 40 is 99% (equilibrium conversion at the converter exit temperature is 99.5%). Converter 40 exit stream 65 is condensed at 500° F. in primary acid condenser/boiler 39 generating high pressure steam (600 psi) and producing stream 5 which is separated in condensate drum 14 into condensate stream 3, comprising 99+% H₂SO₄, and vapor stream 2 containing O₂, SO₃, SO₂, and H₂SO₄. The vapor stream is further cooled in a vent condenser (not shown) generating stream 6 which is separated in drum 27 into tail gas stream 7 and additional acid condensate stream 24 which combines with stream 3 to form stream 13.

Hot acid product stream 13 contains a small amount of SO₂ (˜500 ppm). A stabilizer column (not shown) can be added to the flow scheme to remove the SO₂ which would then be joined with the tail gas stream. The SO₂ in the combined streams can then be recovered by absorption (not shown) in the cold spent acid feed and recycled to the decomposer.

TABLE 1

| | Stream No. | | | | |
|---|---|---|---|---|---|
| | 2 | 3 | 4 | 5 | 6 |
| Conditions | | | | | |
| Temperature ° F. | 498.1 | 498.1 | 100 | 500 | 150 |
| Pressure, psi | 15 | 15 | 36 | 15 | 15 |
| Vapor fraction | 1 | 0 | 0 | 0.049 | 0.955 |
| Mole flow, lb moles/hr | 12.242 | 116.996 | 140.287 | 244.845 | 12.204 |
| Mass flow, lb/hr total | 474.401 | 11350.12 | 12500 | 11825.26 | 474.401 |
| Mass flow, lb/hr vapor | 474.401 | 0 | 0 | 445.246 | 421.002 |
| Mass flow, lb/hr liquid | 0 | 11350.12 | 12500 | 11380.02 | 53.399 |
| Volume flow, ft³/hr total | 8387.937 | 120.581 | 125.628 | 8323.057 | 5084.732 |
| Volume flow, ft³/hr vapor | 8387.937 | 0 | 0 | 8282.056 | 5084.243 |
| Volume flow, ft³/hr liquid | 0 | 120.581 | 125.628 | 121.021 | 0.49 |
| Enthalpy, MMBtu/hr | −0.305 | −39.019 | −44.323 | −39.324 | −0.362 |
| Components, lb/hr | | | | | |
| H₂O | 0.682 | 0.177 | 375 | 2109.692 | 0 |
| H₂SO₄ | 48.568 | 11165.29 | 11500 | 18.293 | 52.282 |
| H₃0+ | 0 | 27.607 | 0 | 0 | 0 |
| HSO₄− | 0 | 140.879 | 0 | 0 | 0 |
| SO₄−2 | 0 | 0 | 0 | 0 | 0 |
| SO₃ | 50.744 | 9.533 | 0 | 9316.235 | 47.713 |
| O₂ | 334.409 | 0.923 | 0 | 335.332 | 334.409 |
| CO₂ | 0 | 0 | 0 | 0 | 0 |
| N-EIC-01 | 0 | 0 | 625 | 0 | 0 |
| Sulfur | 0 | 0 | 0 | 0 | 0 |
| SO₂ | 39.998 | 5.713 | 0 | 45.711 | 39.998 |
| N₂ | 0 | 0 | 0 | 0 | 0 |
| NaNO₂ | 0 | 0 | 0 | 0 | 0 |
| NaNO₃ | 0 | 0 | 0 | 0 | 0 |
| KNO₃ | 0 | 0 | 0 | 0 | 0 |
| Carbon | 0 | 0 | 0 | 0 | 0 |

| | Stream No. | | | | |
|---|---|---|---|---|---|
| | 7 | 9 | 11 | 13 | 19 |
| Conditions | | | | | |
| Temperature ° F. | 149.9 | 100 | 500 | 496.8 | 175.3 |
| Pressure, psi | 15 | 20 | 13.7 | 15 | 11.7 |
| Vapor fraction | 1 | 0 | 1 | 0 | 0.996 |
| Mole flow, lb moles/hr | 11.655 | 3.372 | 372.628 | 117.532 | 234.552 |
| Mass flow, lb/hr, total | 420.956 | 952.722 | 12121.69 | 11403.57 | 9625.264 |
| Mass flow, lb/hr vapor | 420.956 | 0 | 12121.69 | 0 | 9609.481 |
| Mass flow, lb/hr liquid | 0 | 952.722 | 0 | 11403.57 | 15.783 |
| Volume flow, ft³/hr total | 5083.054 | 19.66 | 279415.1 | 121.075 | 135103.9 |
| Volume flow, ft³/hr vapor | 5083.054 | 0 | 279415.1 | 0 | 134103.6 |
| Volume flow, ft³/hr liquid | 0 | 19.66 | 0 | 121.075 | 0.269 |
| Enthalpy, MMBtu/hr | −0.172 | −0.784 | −40.129 | −39.208 | −26.985 |
| Components, lb/hr | | | | | |
| H₂O | 0 | 0 | 4599.929 | 0.176 | 2113.052 |
| H₂SO₄ | 0.003 | 0 | 0 | 11220.2 | 0 |
| H₃0+ | 0 | 0 | 0 | 27.353 | 0 |
| HSO₄− | 0 | 0 | 0 | 139.582 | 0 |
| SO₄−2 | 0 | 0 | 0 | 0 | 0 |
| SO₃ | 46.757 | 0 | 0 | 9.411 | 0 |
| O₂ | 334.367 | 0 | 0 | 0.965 | 0 |
| CO₂ | 0 | 0 | 0 | 0 | 0 |
| N-EIC-01 | 0 | 952.722 | 9.553 | 0 | 0 |
| Sulfur | 0 | 0 | 0 | 0 | 0 |
| SO₂ | 39.829 | 0 | 7512.212 | 5.882 | 7512.212 |
| N₂ | 0 | 0 | 0 | 0 | 0 |
| NaNO₂ | 0 | 0 | 0 | 0 | 0 |
| NaNO₃ | 0 | 0 | 0 | 0 | 0 |
| KNO₃ | 0 | 0 | 0 | 0 | 0 |
| Carbon | 0 | 0 | 0 | 0 | 0 |

Stream No.

| | 24 | 30 | 31 | 32 |
|---|---|---|---|---|
| Conditions | | | | |
| Temperature ° F. | 149.9 | 353.2 | 694.7 | 500 |
| Pressure, psi | 15 | 28 | 30 | 13.7 |
| Vapor fraction | 0 | 1 | 0 | 0 |
| Mole flow, lb moles/hr | 0.549 | 234.552 | 2869.194 | 1341.338 |
| Mass flow, lb/hr, total | 53.445 | 9625.264 | 250000 | 1341.338 |
| Mass flow, lb/hr vapor | 0 | 9625.264 | 0 | 9.549 |
| Mass flow, lb/hr liquid | 53.445 | 0 | 250000 | 0.139 |
| Volume flow, ft³/hr total | 0.491 | 72466.08 | 45960.09 | |
| Volume flow, ft³/hr vapor | 0 | 72466.08 | 0 | 0 |
| Volume flow, ft³/hr liquid | 0.491 | 0 | 45960.09 | 0 |
| Enthalpy, MMBtu/hr | −0.189 | −26.583 | −435.262 | 0 |
| Components, lb/hr | | | | |
| H₂O | 0 | 2113.052 | 0 | 0 |
| H₂SO₄ | 52.278 | 0 | 0 | 0 |
| H₃0+ | 0 | 0 | 0 | 0 |
| HSO₄− | 0 | 0 | 0 | 0 |
| SO₄−2 | 0 | 0 | 0 | 0 |
| SO₃ | 0.956 | 0 | 0 | 0 |
| O₂ | 0.041 | 0 | 0 | 0 |
| CO₂ | 0 | 0 | 0 | 0 |
| N-EIC-01 | 0 | 0 | 0 | 0 |
| Sulfur | 0 | 0 | 0 | 0 |
| SO₂ | 0.169 | 7512.212 | 0 | 0 |
| N₂ | 0 | 0 | 0 | 1341.339 |
| NaNO₂ | 0 | 0 | 79184.38 | 0 |
| NaNO₃ | 0 | 0 | 17070.64 | 0 |
| KNO₃ | 0 | 0 | 153745 | 12.001 |
| Carbon | 0 | 0 | 0 | 1 |

| | Stream No. | | | | |
|---|---|---|---|---|---|
| | 43 | 48 | 49 | 50 | 52 |
| Conditions | | | | | |
| Temperature ° F. | 150 | 195.3 | 205.8 | 150 | 200 |
| Pressure, psi | 11.7 | 12 | 13 | 11.7 | 13 |
| Vapor fraction | 1 | 1 | 0 | 0 | 0 |
| Mole flow, lb moles/hr | 153.388 | 81.164 | 138.076 | 219.214 | 0.034 |
| Mass flow, lb/hr, total | 7671.673 | 1953.591 | 2496.43 | 4450.021 | 9.564 |
| Mass flow, lb/hr vapor | 7671.673 | 1953.591 | 0 | 0 | 0 |
| Mass flow, lb/hr liquid | 0 | 0 | 2496.43 | 4450.021 | 9.564 |
| Volume flow, ft³/hr total | 85774 | 47541.43 | 41.683 | 70.521 | 0.198 |
| Volume flow, ft³/hr vapor | 85774 | 48541.43 | 0 | 0 | 0 |
| Volume flow, ft³/hr liquid | 0 | 0 | 41.683 | 70.521 | 0.198 |
| Enthalpy, MMBtu/hr | −18.369 | −8.616 | −16.661 | −26.823 | −0.008 |
| Components, lb/hr | | | | | |
| H₂O | 843.096 | 1269.956 | 2486.877 | 3756.833 | 0.012 |
| H₂SO₄ | 0 | 0 | 0 | 0 | 0 |
| H₃0+ | 0 | 0 | 0 | 0 | 0 |
| HSO₄− | 0 | 0 | 0 | 0 | 0 |
| SO₄−2 | 0 | 0 | 0 | 0 | 0 |
| SO₃ | 0 | 0 | 0 | 0 | 0 |
| O₂ | 0 | 0 | 0 | 0 | 0 |
| CO₂ | 0 | 0 | 0 | 0 | 0 |
| N-EIC-01 | 0 | 0 | 9.553 | 9.553 | 9.553 |
| Sulfur | 0 | 0 | 0 | 0 | 0 |
| SO₂ | 6828.578 | 683.635 | 0 | 683.635 | 0 |
| N₂ | 0 | 0 | 0 | 0 | 0 |
| NaNO₂ | 0 | 0 | 0 | 0 | 0 |
| NaNO₃ | 0 | 0 | 0 | 0 | 0 |
| KNO₃ | 0 | 0 | 0 | 0 | 0 |
| Carbon | 0 | 0 | 0 | 0 | 0 |

| | Stream No. | | | | |
|---|---|---|---|---|---|
| | 53 | 54 | 65 | 73 | 74 |
| Conditions | | | | | |
| Temperature ° F. | 315.7 | 100 | 707.9 | 650 | 700 |
| Pressure, psi | 28 | 13 | 15 | 41 | 25 |
| Vapor fraction | 1 | 0 | 1 | 0 | 1 |
| Mole flow, lb moles/hr | 303.304 | 138.042 | 245.031 | 2869.194 | 303.304 |
| Mass flow, lb/hr, total | 11825.26 | 2486.865 | 11825.26 | 250000 | 11825.26 |
| Mass flow, lb/hr vapor | 11825.26 | 0 | 11825.56 | 0 | 11825.26 |
| Mass flow, lb/hr liquid | 0 | 1486.865 | 0 | 250000 | 0 |
| Volume flow, ft³/hr total | 89569.17 | 40.622 | 204403.7 | 45960.09 | 150805.6 |
| Volume flow, ft³/hr vapor | 89569.17 | 0 | 204403.7 | 0 | 150805.6 |
| Volume flow, ft³/hr liquid | 0 | 40.622 | 0 | 45960.09 | 0 |
| Enthalpy, MMBtu/hr | −26.549 | −17.099 | −30.369 | −439.081 | −25.45 |
| Components, lb/hr | | | | | |
| H₂O | 2113.052 | 2486.052 | 2113.052 | 0 | 2113.052 |
| H₂SO₄ | 0 | 0 | 0 | 0 | 0 |
| H₃0+ | 0 | 0 | 0 | 0 | 0 |
| HSO₄− | 0 | 0 | 0 | 0 | 0 |
| SO₄−2 | 0 | 0 | 0 | 0 | 0 |
| SO₃ | 0 | 0 | 9331.169 | 0 | 0 |
| O₂ | 2200 | 0 | 335.332 | 0 | 2200 |
| CO₂ | 0 | 0 | 0 | 0 | 0 |
| N-EIC-01 | 0 | 0 | 0 | 0 | 0 |
| Sulfur | 0 | 0 | 0 | 0 | 0 |
| SO₂ | 7512.212 | 0 | 45.711 | 0 | 7512.12 |
| N₂ | 0 | 0 | 0 | 0 | 0 |
| NaNO₂ | 0 | 0 | 0 | 79184.36 | 0 |
| NaNO₃ | 0 | 0 | 0 | 17070.64 | 0 |
| KNO₃ | 0 | 0 | 0 | 153745 | 0 |
| Carbon | 0 | 0 | 0 | 0 | 0 |

Stream No.

| | 76 | 77 |
|---|---|---|
| Conditions | | |
| Temperature ° F. | 707.5 | 150 |
| Pressure, psi | 30 | 100 |
| Vapor fraction | 0 | 1 |
| Mole flow, lb moles/hr | 2869.194 | 68.953 |
| Mass flow, lb/hr, total | 250000 | 2200 |
| Mass flow, lb/hr vapor | 0 | 2200 |
| Mass flow, lb/hr liquid | 250000 | 0 |
| Volume flow, ft³/hr total | 45960.09 | 4491.746 |
| Volume flow, ft³/hr vapor | 0 | 4491.746 |
| Volume flow, ft³/hr liquid | 45960.09 | 0 |
| Enthalpy, MMBtu/hr | −434.163 | 0.034 |
| Components, lb/hr | | |
| H₂O | 0 | 0 |
| H₂SO₄ | 0 | 0 |
| H₃0+ | 0 | 0 |
| HSO₄− | 0 | 0 |
| SO₄−2 | 0 | 0 |
| SO₃ | 0 | 0 |
| O₂ | 0 | 2200 |
| CO₂ | 0 | 0 |
| N-EIC-01 | 0 | 0 |
| Sulfur | 0 | 0 |
| SO₂ | 0 | 0 |
| N₂ | 0 | 0 |
| NaNO₂ | 791184.38 | 0 |
| NaNO₃ | 17070.64 | 0 |
| KNO₃ | 153745 | 0 |
| Carbon | 0 | 0 |

### EXAMPLE 1

This example illustrates low temperature decomposition of spent sulfuric acid by heating 10 cc's spent sulfuric acid from an alky pilot plant in 50 cc fresh sulfuric acid. Gas evolved at 160-190° C. and was steady at 200° C. The first drop of overhead condensate was observed at 288° C. Sulfuric acid was being recovered overhead at 315° C. Black solids were formed in the pot

A similar test was made with only fresh H₂SO₄ that yielded little or no SO₂ evolution. The test was repeated with iron oxide catalyst, but still no significant decomposition occurred up to the boiling point of sulfuric acid (about 315° C.).

### EXAMPLE 2

### Set Up:

A 500 cc, 3 neck flask with heating mantle, insulated top and Teflon® coated magnetic stirring bar. The flask was fitted with an acid feed inlet, thermometer and overhead vapor takeoff (atm press). The overhead takeoff included a condenser, liquid receiver and vent gas takeoff port to a gas sampling bag

### Spent Acid Feed Stock:

### Spent acid used was about 90% H₂SO₄, 2.5% H₂O, with the remainder being ASO and HC. TC=5.2%

Spent acid was decomposed in various mediums:

| | normalized vol % in vent gas | | | | |
|---|---|---|---|---|---|
| | (excludes water saturation at room temp) | | | | |
| Medium | Temp ° C. | Temp. ° F. | SO₂ | CO₂ | CO |
| in sulfuric acid | 300 | 572 | 81.9% | 16.8% | 1.3% |
| | 280 | 536 | 82.1% | 17.4% | 0.6% |
| | 285 | 545 | 88.0% | 10.6% | 1.4% |
| | 225 | 437 | 88.3% | 9.7% | 1.9% |
| | 220 | 428 | 89.9% | 8.5% | 1.6% |
| in molten sulfur | 280 | 536 | 94.1% | 4.2% | 1.7% |
| | 270 | 518 | 96.5% | 2.6% | 0.9% |
| | 262 | 504 | 94.4% | 3.7% | 1.9% |
| in gas oil | 258 | 496 | 96.2% | 2.4% | 1.4% |
| | 203 | 397 | 100.0% | 0.0% | 0.0% |
| “dry pot” method | 200 | 392 | 93.1% | 6.3% | 0.6% |
| | 427 | 801 | 88.8% | 10.2% | 1.0% |
| | 443 | 830 | 87.9% | 11.2% | 1.0% |

The gas oil results were superior to the other mediums evaluated. The specifics of the gas oil run are set out below.

| Charge: | 100 ml Motiva ® Gas Oil (~83 g) in pot initially | |
|---|---|---|
| | 18 ml Spent Acid (~30.6 g), 1 hour steady addition time at | |
| | temp | |
| | Pot Temp ° F. | 397 |
| Overhead: | water | 9.1 g (saturated with SO₂ at room temp) |
| | oil | 2.9 g |
| | vent gas | ~19.4 g by difference (113.6 g in − 94 g |
| | | Pot + OH out); vent contains only SO₂ + |
| | | water saturation + light hydrocarbons |
| | | (no CO₂ or CO) |
| | recovered SO₂ | ~18 g (.28 mols SO₂ out = .28 mols |
| | | H2SO₄ in) |
| Pot residual: | oil | 70 g |
| | solids | 12 g (filtered, acetone washed, air dried) |

The invention claimed is:

1. A process for the regeneration of spent sulfuric acid contaminated with water to produce pure concentrated acid comprising the steps of:
(a) dispersing the spent sulfuric acid and a reducing agent in a decomposition zone and
(b) heating the resultant mixture of spent sulfuric acid and reducing agent to decompose the spent sulfuric acid to sulfur dioxide and water.

2. The process according to claim 1 wherein the spent sulfuric acid and reducing agent are dispersed onto a solid surface as a thin layer.

3. The process according to claim 2 wherein said reducing agent comprises hydrocarbon contaminant.

4. The process according to claim 3 comprising decomposing the hydrocarbon to carbon and precipitating the carbon out of the mixture as solid particulates.

5. The process according to claim 3 wherein hydrocarbon is added to the spent sulfuric acid.

6. The process according to claim 4 wherein said hydrocarbon comprises gas oil boiling in the range of said hydrocarbon contaminant.

7. The process according to claim 4 wherein the solid surface comprises a portion of precipitated solid carbon particulates.

8. The process according to claim 1 wherein the temperature in the decomposition zone is in the range of 300 to 600° F.

9. The process according to claim 8 wherein the temperature in the decomposition zone is less than about 500° F.

10. The process according to claim 1 wherein the decomposition zone is operated under a vacuum.

11. The process according to claim 3 further comprising the steps of:
(c) precipitating the carbon out of the mixture as solid particulates;
(d) converting the sulfur dioxide to sulfur trioxide in a converter by reacting the sulfur dioxide with oxygen in the presence of water; and
(e) condensing sulfuric acid of about one hundred percent sulfuric acid.

12. The process according to claim 11 wherein the regenerated sulfuric acid of about one hundred percent sulfuric acid is condensed in a boiler that generates high pressure steam.

13. The process according to claim 11 wherein heat is recovered from the conversion of sulfur dioxide to sulfur trioxide and used to provide heat to the decomposition zone.

14. A process for the regeneration of sulfuric acid contaminated with hydrocarbons and water to produce pure concentrated acid comprising the steps of:
(a) dispersing the spent sulfuric acid and hydrocarbon onto a solid surface as a thin layer in a decomposition reactor;
(b) heating the resultant mixture to decompose the spent sulfuric acid in the presence of a hydrocarbon reducing agent to sulfur dioxide, carbon and water;
(c) precipitating the carbon out of the mixture as solid particulates;
(d) converting the sulfur dioxide to sulfur trioxide in a converter by reacting the sulfur dioxide with oxygen in the presence of water; and
(e) condensing essentially one hundred percent sulfuric acid.

15. The process according to claim 14 wherein additional heavy hydrocarbon boiling in the range of a gas oil is added to the spent sulfuric acid.

16. The process according to claim 14 wherein the solid surface comprises a portion of the precipitated solid carbon particulates.

17. The process according to claim 14 wherein the temperature in the decomposition reactor is about 500° F.

18. The process according to claim 14 wherein the decomposition reactor is operated under a vacuum.

19. The process according to claim 14 wherein about one hundred percent sulfuric acid is condensed in a boiler that generates high pressure steam.

20. A process for the regeneration of spent sulfuric acid contaminated with water to produce pure concentrated acid comprising the steps of:
(a) dispersing the spent sulfuric acid and a reducing agent in a decomposition zone and
(b) heating ° F. the resultant mixture of spent sulfuric acid and reducing agent to a temperature in the range of 300 to 600 to decompose the spent sulfuric acid to sulfur dioxide and water.
